(19) United States
(12) Patent Application Publication
(10) Pub. No.: US 2011/0027643 A1
(43) Pub. Date: Feb. 3, 2011

(54) Button Type Cell Battery with Metallic Framework

(75) Inventors: Qinghai Li, Shandong (CN); Deli Hao, Shandong (CN)

Correspondence Address: GLOBAL IP SERVICES, 7285 W. Eagle Court, Winton, CA, 95388, US

(73) Assignee: SHANDONG SHENGONGHAITE ELECTRONIC TECHNOLOGY LTD., Zaozhuang, Shandong (CN)

(21) Appl. No.: 12/918,429

(22) PCT Filed: Jan. 31, 2008
(86) PCT No.: PCT/CN08/00243

§ 371 Date: Aug. 19, 2010

(30) Foreign Application Priority Data
Nov. 22, 2007 (CN) 200710150286.1

(51) Int. Cl. H01M 2/02

(52) U.S. Cl. 429/163

(57) ABSTRACT

A 1.5V Li-FeS₂ button-type cell battery with metal skeleton, including two half cases in which separator is provided and electrolyte is filled, positive and negative electrodes provided at the two sides of the separator, the separator being microporous polypropylene membrane, or microporous polyethylene membrane, or the combined membrane thereof, or polypropylene felt, or fibrous papery membrane, or glass fiber, the positive electrode comprised of a collector filled with positive active material, the metal skeleton including foamed nickel, fibrous nickel, foamed iron, foamed copper, foamed aluminum, foamed titanium or sintered stainless steel, the positive electrode material comprising of FeS₂, conductive agent and binder, the negative electrode being metal lithium, lithium-aluminum alloy or lithium silicon alloy, the electrolyte being obtained by lithium salt dissolved in organic compound solution.

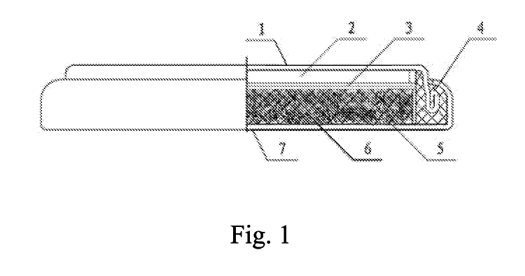

### FIELD OF THE INVENTION

This invention discloses button type cell battery with metallic framework as anode, more particularly a 1.5 V button battery of lithium-iron disulphide with metallic framework as anode, and belongs to the innovation in chemical energy storage technology.

### BACKGROUND OF THE INVENTION

In recent years, the development of electron technology and the greater attention given to the environmental protection bring out the higher demand for electrochemical power source. At present, the 1.5 V button batteries in mainstream market can be divided into two series. One of them is Zn-Mn button battery. This battery is cheap, but its disadvantages include low capacity, large ineffective discharge, easy leakage and bad performance at elevated and reduced temperatures. Another series is Ag-Zn button battery. Although the capacity of this battery is 30% higher than Zn-Mn button battery, its anode is prepared by expensive silver oxide. The Ag-Zn button battery and Zn-Mn button battery usually contain mercury. The button batteries are widely applied in electrical appliances such as wrist watch, sports shoes, calculators and meters, so they easily cause environmental pollution when these electronic products are discarded to solid wastes.

The active material of anode in button battery of lithium-iron disulphide is iron disulphide. The cathode uses metallic lithium or lithium-aluminum alloy. The working voltage is 1.5 V, the discharge capacity is higher than the Ag-Zn battery with same model, and it does not cause environmental pollution. However, the previous button battery of lithium-iron disulphide has the expansion problem in discharge process, influencing the use performance. The 1.5 V button battery of lithium-iron disulphide with bubbling metal as anode in this invention solves the expansion problem and improves the quality.

### SUMMARY OF THE INVENTION

The purpose of this invention is to provide a 1.5 V button battery of lithium-iron disulphide with metallic framework as anode. The discharge capability of this battery is stable. It has no expansion problem in discharge process and does not cause environmental pollution.

The invention achieves this by the following technical solutions: a kind of 1.5 V button battery of lithium-iron disulphide with metallic framework as anode, which consists of two metal semi-shells. The diaphragm is set in the shell, and the shell is filled with electrolyte. The anode and cathode are set in two sides of diaphragm. The said diaphragm is micro-porous polypropylene (PP) or polyethylene (PE) thin membrane, or their combined composite membrane, or polypropylene (PP) felt, or fibrous paper thin membrane, or fibre glass. The said anode consists of current collector and anode materials filled in current collector. The anode material consists of iron disulfide, conductive agent (one or combination from graphite, carbon soot, iron powder, copper powder, silver powder and nickel powder) and adhesives (one or combination from polyethylene, polyfluortetraethylene, polyoxyethylene, acrylic ester and carboxymethylcellulose). The said cathode is metallic lithium, lithium-aluminum alloy or lithium-silicon alloy. The said electrolyte is one ore mixed solution of LiPF₆, LiClO₄, dioxalic acid lithium borate, LiBF₄, LiI or LiCl in ethylene carbonate, propylene carbonate, diethyl carbonate, dimethyl carbonate, glycol dimethyl ether, acetonitrile, methyl ethyl carbonate or γ-butyrolactone.

It is characterized in that the current collector is metallic framework, which is selected from bubbling nickel, nickel fiber, bubbling iron, bubbling copper, bubbling aluminum, bubbling titanium or sintered stainless steel.

The invention has the advantages of that, the anode of button battery uses bobbling metal or sintered stainless steel as framework, which all belong to porous metals. The framework is filled with anode materials consisted of iron disulfide, conductive agent and adhesives. This anode can inhibit the expansion problem in discharge process. Therefore, it enhances the stability of discharge voltage, increases the discharge capacity, improves the overall quality, enlarges the application scope of Li-Fe button battery, and enhanced competition ability of Li-Fe button battery in high-end electronic instruments and meters. Moreover, it simplifies the production process, which is suitable for the large-scale commercial production.

### DETAIL DESCRIPTION OF THE INVENTION:

### Example 1

50 g of iron disulfide powder and 50 g of graphite powder were mixed uniformly. Then, 100 g of polyoxyethylene water solution (mass fraction of 20%) was added. The sample was stirred to pulpiness with glass bar. The prepared pulpiness was coated on bubbling nickel (10 cm×10 cm×2 mm, porosity of 83%) with oxhorn spoon. The pulpiness should be fully filled in the space of bubbling nickel. Then, the bubbling nickel was put in vacuum oven (150° C., 1 KPa) for 12 h. The dried bubbling nickel was pressed to 1 mm thickness with tablet machine, and then cut to a around cake with diameter of Φ2.2 mm. The prepared around cake was put in vacuum oven (150° C., 1 KPa) for 12 h, and then transferred to a drying environment (relative humidity ≦1%) for anode use. The lithium cake (Φ2.2 mm, thickness of 0.5 mm) was put into stainless steel shell. The fibre glass diaphragm was covered on lithium cake. The anode was put on diaphragm, and then 0.5 g of I M LiCiO₄ (in 1:3 of PC and DME) was filled as electrolyte. After covering another stainless steel shell, it was sealed on oil hydraulic press. The button battery was obtained.

### Example 2

80 g of natural iron disulfide powder and 20 g of graphite powder were mixed uniformly. Then, 100 g of acrylate water solution (mass fraction of 15%) was added. The sample was stirred to pulpiness with glass bar. The prepared pulpiness was coated on bubbling copper (10 cm×10 cm×2 mm, porosity of 45%) with oxhorn spoon. The pulpiness should be fully filled in the space of bubbling copper. Then, the bubbling copper was put in vacuum oven (150° C.) for 12 h. The dried bubbling copper was pressed to 1 mm thickness with tablet machine, and then cut to a around cake with diameter of Φ6.2 mm. The prepared around cake was put in vacuum oven (150° C.) for 12 h, and then transferred to a drying environment (relative humidity ≦1%) for anode use. The lithium-aluminum alloy cake (Φ6.2 mm, thickness of 0.8 mm, Li: 98% wt, Al: 2% wt) was put into stainless steel shell. The fibre glass diaphragm was covered on lithium-aluminum alloy cake. The anode was put on diaphragm, and then 3.5 g of I M LiI (in 1:3:6 of PC, DME and DOL) was filled as electrolyte. After covering another stainless steel shell, it was sealed on oil hydraulic press. The button battery was obtained.

### Example 3

70 g of artificially synthesized iron disulfide powder and 30 g of copper powder were mixed uniformly. Then, 100 g of polyfluortetraethylene emulsion (mass fraction of 5%) was added. The sample was stirred to pulpiness with glass bar. The prepared pulpiness was coated on sintered stainless steel (10 cm×10 cm×2 mm) with oxhorn spoon. The pulpiness should be fully filled in the space of sintered stainless steel (porosity of 60%). Then, the sintered stainless steel was put in vacuum oven (150° C.) for 12 h. The dried sintered stainless steel was pressed to 1 mm thickness with tablet machine, and then cut to a around cake with diameter of Φ8.2 mm. The prepared around cake was put in vacuum oven (150° C.) for 12 h, and then transferred to a drying environment (relative humidity ≦1%) for anode use. The lithium-aluminum alloy cake (Φ8.0 mm, thickness of 0.8 mm, Li: 98% wt, Al: 2% wt) was put into nickel-plated iron shell. The fibre glass diaphragm was covered on lithium-aluminum alloy cake. The anode was put on diaphragm, and then 4.4 g of 0.8 M LiBOB (in 1:1:5:3 of PC, EC, DEC and GBL) was filled as electrolyte. After covering another nickel-plated iron shell, it was sealed on oil hydraulic press. The button battery was obtained.

### Example 4

90 g of artificially synthesized iron disulfide powder and 10 g of nickel powder were mixed uniformly. Then, 100 g of polyethylene ethanol solution (mass fraction of 5%) was added. The sample was stirred to cream with glass bar. The prepared cream was coated on bubbling titanium (10 cm×10 cm×2 mm, porosity of 95%) with oxhorn spoon. The cream should be fully filled in the space of sintered stainless steel. Then, the bubbling titanium was put in vacuum oven (150° C.) for 12 h. The dried bubbling titanium was pressed to 1 mm thickness with tablet machine, and then cut to a around cake with diameter of Φ2.2 mm. The prepared around cake was put in vacuum oven (150° C.) for 12 h, and then transferred to a drying environment (relative humidity ≦1%) for anode use. The lithium cake (Φ2.2 mm, thickness of 0.7 mm) was put into nickel-plated iron shell. The fibre glass diaphragm was covered on lithium cake. The anode was put on diaphragm, and then 0.4 g of 1.2 M LiPF₆ (in 1:1:4:1 of PC, EC, DEC and GBL) was filled as electrolyte. After covering another nickel-plated iron shell, it was sealed on oil hydraulic press. The button battery was obtained.

1. (canceled)

2. A button type cell battery with metallic framework comprising:
two metal semi-shells filled with electrolyte and separated by a diaphragm;
an anode and a cathode being set in the two metal semi-shells at two sides of the diaphragm;
the anode comprising a current collector and anode material filed in the current collector, the anode material being a mixture of iron disulfide, conductive and adhesives;
the cathode being made from metallic lithium, lithium-aluminum alloy or lithium-silicon alloy;
the current collector being made from a metallic framework, which is selected from bubbling nickel, nickel fiber, bubbling iron, bubbling copper, bubbling aluminum, bubbling titanium or sintered stainless steel.

3. The button type cell battery with metallic framework of claim 1, wherein the anode material comprises 50 g of iron disulfide powder, 20 g of graphite powder and 100 g of acrylic ester water solution (mass fraction of 20%).

4. The button type cell battery with metallic framework of claim 1, wherein the anode material comprises 90 g of artificially synthesized iron disulfide powder, 10 g nickel powder and 100 g of polyethylene ethanol solution (mass fraction of 5%).

5. The button type cell battery with metallic framework of claim 1, wherein the anode material comprises 70 g of artificially synthesized iron disulfide powder, 30 g of copper powder and 100 g of polyfluortetraethylene emulsion (mass fraction of 5%).
